(19) United States
(12) Patent Application Publication
(10) Pub. No.: US 2010/0325059 A1
(43) Pub. Date: Dec. 23, 2010

(54) METHOD TO FACILITATE ENGAGEMENT OF A COMPANY WITH AN AVAILABLE POSITION

(76) Inventor: Jeremy Lappin, New York City, NY (US)

Correspondence Address: SCHOX PLC, 500 3rd Street, Suite 515, San Francisco, CA, 94107, US

(21) Appl. No.: 12/526,007

(22) PCT Filed: Feb. 5, 2008
(86) PCT No.: PCT/US2008/053088

§ 371 Date: Jul. 5, 2010

Related U.S. Application Data
(60) Provisional application No. 60/888,178, filed on Feb. 5, 2007.

(51) Int. Cl. G06Q 10/00

(52) U.S. Cl. 705/321

(57) ABSTRACT

A method to encourage a recruiter to engage a company with an available position on a computer network that accepts information about the available position from the company; accepts information about a candidate for the available position from a recruiter and submits the information about the candidate to the company; and upon the selection by the company of a candidate for the available position, accepts payment from the company and transmits a portion of the payment to the recruiter. The method of the preferred embodiments include allowing the recruiter to invite a company to a computer network, accepting contact information for the company, and allowing the recruiter to access the contact information of the company. The method may include transmitting an invitation code to the company, transmitting a portion of the payment to the inviter of the company, or allowing the recruiter to invite only a predetermined number of companies.

### CROSS-REFERENCE TO RELATED APPLICATIONS

This application claims the benefit of U.S. Provisional Application No. 60/888,178 filed on 5 Feb. 2007 and entitled “Method to Facilitate Engagement of a Company with an Available Position”, which is incorporated in its entirety by this reference.

This application is related to PCT application PCT/US2006/044168 filed on 13 Nov. 2006 and entitled “Method to Facilitate Engagement and Communication between a Company and a Recruiter including a Bounty” and to PCT application PCT/US2006/044041 filed on 13 Nov. 2006 and entitled “Method to Facilitate Engagement and Communication between a Company and a Recruiter”, which are both incorporated in their entirety by this reference. Both PCT applications claim the benefit of US Provisional Application No. 60/747,373 filed 16 May 2006 and entitled “System and Method to Facilitate a Marketplace on a Network”, the benefit of U.S. Provisional Application No. 60/806,603 filed 5 Jul. 2006 and entitled “Method for Finding Job Candidates with Active Recruiters”, and the benefit of U.S. Provisional Application No. 60/806,606 filed 5 Jul. 2006 and entitled “Method for Submitting Job Candidates”, which are all incorporated in their entirety by this reference.

### TECHNICAL FIELD

This invention relates generally to the e-commerce field, and more specifically to an improved method to facilitate engagement of a company with an available position.

### BACKGROUND

With the increasing mobility and sophistication of the modern labor force, companies often need to fill an available position quickly. Because of the depth and breadth of the expertise of most companies, it is impractical for them to engage candidates directly through a centralized human resources department. As such, many companies utilize one or more recruiters for the purpose of finding appropriate candidates for the required positions.

An unfortunate result of the use of recruiters is that companies are often inundated with information about candidates that are not qualified for one reason or another. Moreover, companies are often forced to deal with inexperienced or otherwise undesirable recruiters that do not have the appropriate skills for attracting the necessary talent. As a result, the combination of unqualified candidates and inefficient or inexperienced candidates forces companies to invest substantial time and resources in the evaluation and eventual rejection of prospective candidates. Ironically, the proliferation of inexperienced recruiters submitting the information of unqualified candidates places such a significant burden on the companies that for all practical purposes, they might be just as well served to perform their recruiting through their own firm. Thus, there is a need in the e-commerce field to create an improved, new and useful method to facilitate engagement of a company with an available position.

### SUMMARY

Accordingly, the present invention includes an improved, new and useful method to encourage a recruiter to engage a company with an available position on a computer network. The computer network preferably accepts information about the available position from the company; accepts information about a candidate for the available position from a recruiter and submits the information about the candidate to the company; and upon the selection by the company of a candidate for the available position, accepts payment from the company and transmits a portion of the payment to the recruiter. The method of the preferred embodiments include allowing the recruiter to invite a company to a computer network, accepting contact information for the company, and allowing the recruiter to access the contact information of the company. In variations of the preferred embodiments, the method may include transmitting an invitation code to the company, transmitting a portion of the payment to the inviter of the company, or allowing the recruiter to invite only a predetermined number of companies.

### BRIEF DESCRIPTION OF THE FIGURES

FIGS. 1 and 2 are flowcharts illustrating the steps of a method of a preferred embodiment of the invention.

FIG. 3 is a schematic diagram illustrating the parties involved in the method of the preferred embodiment.

### DETAILED DESCRIPTION OF THE PREFERRED EMBODIMENTS

The following description of the preferred embodiments of the invention is not intended to limit the invention to these preferred embodiments, but rather to enable any person skilled in the art to make and use this invention.

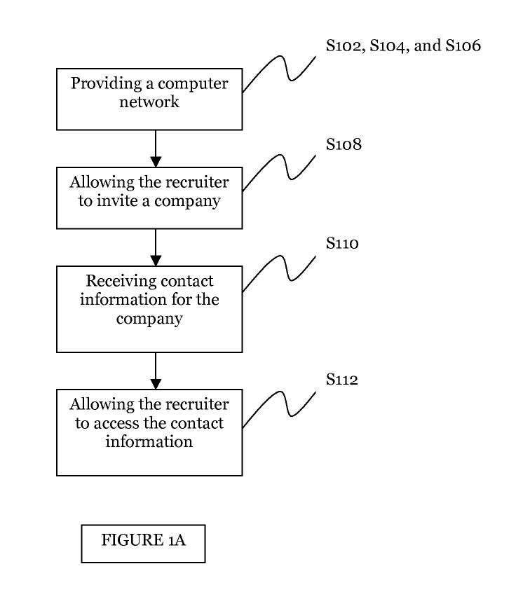

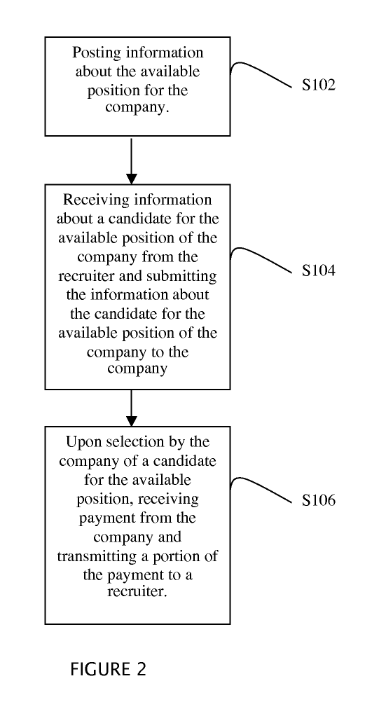

As shown in FIGS. 1 and 2, the method of the preferred embodiment includes a series of steps to facilitate engagement of a company with an available position. As used herein, the term “company” refers to an entity or natural person that is engaged in a business. The term “available position” refers to any opportunity for a relationship between the company and any natural person or entity (a “candidate”). The term “relationship” includes, for example, an employment agreement, a service agreement, or any other contractual arrangement involving payment by the company to the candidate for due consideration according to the relationship. The term “recruiter” refers to any natural person or entity that engages, on a limited or exclusive basis, in the business of facilitating the entry of a candidate and a company into a relationship. The term “bounty” is a payment or reward, preferably in the form of a monetary transaction, from the company to the recruiter for the acceptance of a submitted candidate.

### 1. The Computer Network

Step S102 of the method of the preferred embodiment recites accepting and posting information about the available position for the company. The information about the available position may include any pertinent or requisite skills preferred or required for the available position as well as any background information about the company or the available position. Additionally, the information about the available position may include any necessary submissions by the candidate including any pertinent biographical or working history, including for example a resume, curriculum vitae, writing sample, salary requirements, salary history, employment history, employer references, background check information, professional or paraprofessional licenses, credit history, citizenship status, employment visa status, security clearances, and/or any additional information required for the available position.

Step S104 of the method of the preferred embodiment recites accepting or receiving information about a candidate for the available position of the company from the recruiter and submitting the information about the candidate for the available position to the company. The information about the candidate may include any pertinent biographical or working history, including for example a resume, curriculum vitae, writing sample, salary requirements, salary history, employment history, employer references, background check information, professional or paraprofessional licenses, credit history, citizenship status, employment visa status, security clearances, and/or any additional information required for the available position.

Step S106 of the method of the preferred embodiment recites receiving payment from the company and transmitting a portion of the payment to the recruiter upon selection by the company of a candidate for the available position.

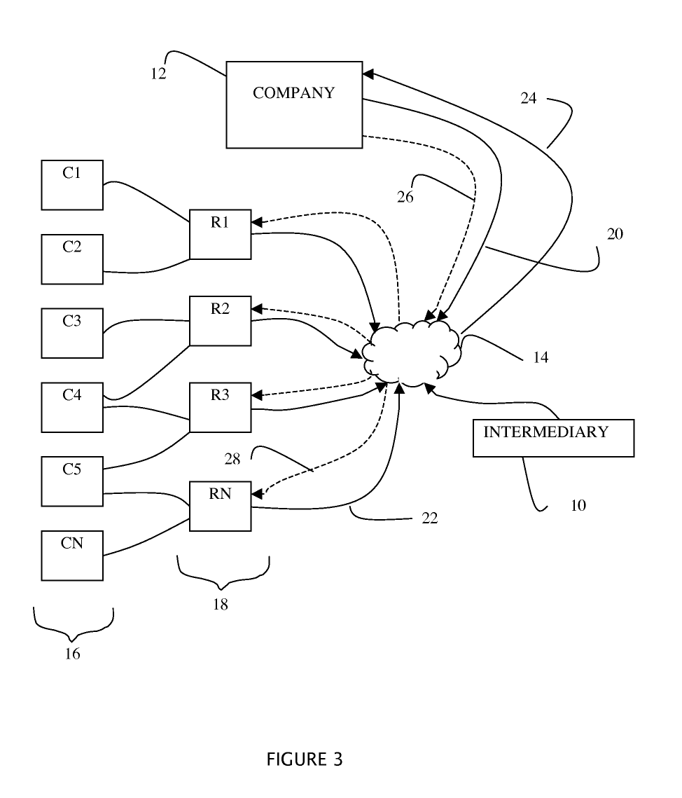

As shown in FIG. 3, an intermediary 10, a company 12, a plurality of recruiters (R1, R2, R3, and RN) 18 and a plurality of candidates (C1, C2, C3, C4, C5 and CN) are operatively connectable, either through wired or wireless means, to a computer network 14. The computer network 14 functions to permit data communications between two or more parties, such as the company 12 and one or more of the plurality of recruiters 18, such that the company 12 and the one or more of the plurality of recruiters 18 need not be in direct, personal contact regarding the available position or any attribute thereof. Moreover, the computer network 14 functions to allow the company 12 to readily post information 20 about the available position to the plurality of recruiters 18 in a simultaneous, interactive, and widely disseminated manner. The computer network 14 further functions to permit the recruiters to submit information about a candidate 22 to the company 12, and for the company 12 to access one or more submissions 24. Lastly, the computer network 14 functions to facilitate the receipt of payment 26 from the company 12 and the transmitting of a portion of the payment 28 to a recruiter 18. The computer network 14 may include any two or more computers that are connectable directly or indirectly through a local or wide-network, including for example the Internet or World Wide Web. Each of the company and the plurality of recruiters may communicate through the computer network 14, for instance through a single website consisting of multiple web pages operated by an intermediary 10.

In the first variation of the method of the preferred embodiment, step S102 may include posting information about the available position on or though any computer that is connected to or connectable to the computer network 14, such as for example a server, personal computer, personal digital assistant, mobile phone or any other combination of hardware and/or software that is adapted to perform machine executable instructions according to the method of the preferred embodiment. Similarly, step S104 may include receiving information about a candidate for the available position of the company from the recruiter and submitting the information about the candidate for the available position to the company on or though any computer that is connected or connectable to the network 14 as described above.

In a second variation of the method of the preferred embodiment, Step S102 includes posting information about the available position for the company and a number of submissions for the available position. The step of posting the number of submissions for the available position functions to inform the company and one or more recruiters as to the probability of a successful selection by the company of a candidate through the laws of supply and demand. As such, the step of posting the number of submissions for the available position further functions to inform the company and one or more recruiters as to the competitiveness of: (1) the company's position with regard to potential candidates, and (2) the one or more recruiters relative prospects of having one of its candidates selected by the company. If the number of submissions is large at a point in time, the company's competitive position is relatively increased while that of each individual recruiter is decreased. Conversely, if the number of submissions is small at a point in time, the company's competitive position is relatively decreased while that of each individual recruiter is increased.

In a third variation of the method of the preferred embodiment, step S102 includes posting a bounty for the available position of the company. The step of posting a bounty for the available position of the company functions to increase the incentives for any one or more recruiters to submit the information about a candidate to the company. The step of posting a bounty for the available position of the company may be performed by the company or any agent of the company. The posting of the bounty is performable over a computer network 14 of the type described above with reference to FIG. 3. Alternatively, the posting of the bounty is performable through any other means or mechanisms not involving a computer network of the type described above. The bounty may include for example a pecuniary award payable in exchange for a successful selection of a candidate for the available position. The bounty may be payable through any means, including cash, check, credit card payment, wire transfer and the like, and may be payable in any currency or denominations thereof.

In a fourth variation of the method of the preferred embodiment, step S104 further includes the step of checking a database of previously submitted information about a candidate for the available position of the company and if information about the candidate for the available position of the company has not been previously submitted, then submitting the information about the candidate for the available position of the company to the company, otherwise informing the recruiter that the information about the candidate for the available position of the company has been previously submitted. The fourth variation of the method of the preferred embodiment functions to prohibit the company from receiving information about any one candidate from multiple recruiters, which would hinder the efficiency and selection process of the company. The performer of this variation of step S104 therefore provides a clearinghouse service to the company by prohibiting multiple submissions of redundant information, which accelerates the efficiency and selection process of the company. The process of checking a database may include, for example, checking for a particular identification of the candidate. The identification may include, for example, the full name, the Social Security Number, the Driver's License Number, the home address, the email address, the phone number (home, work, or mobile), or any other appropriate identification of the candidate. The process of checking a database may alternatively include checking a hash function (a small digital “fingerprint”) of a portion of the submission, such as the resume of the candidate.

### 2. The Invitation Process

As shown in FIGS. 1 and 2, in addition to providing a computer network, the method of the preferred embodiment includes allowing a recruiter to invite companies to the computer network S108, and—upon acceptance of the invitation by the company—receiving contact information for the company S110 and allowing the recruiter to access the contact information of the company S112. The automatic access of the contact information of the company provides both an incentive for the recruiter and a convenience to the parties.

Step S108 of the method of the preferred embodiment recites allowing the recruiter to invite a company to a computer network. Step S108 also preferably includes creating and transmitting an invitation code to the company. The invitation code may be generated at random or pseudo-random, may be generated based on the information of the recruiter, or may be generated by any suitable method. Step S108 also preferably includes checking a database of companies within the computer network and if the invited company is not within the computer network, then facilitating the transmission of the invitation to the company. Otherwise, if the invited company is already within the computer network, the method preferably includes informing the recruiter that the company is already within the computer network and not facilitating the transmission of the invitation to the company. Step S108 may also includes accepting and verifying the invitation code by the company and linking the invited company to the inviter of the company.

Step S110 of the method of the preferred embodiment recites accepting contact information for the company. Preferably, the step of accepting contact information from the company occurs only if the company accepts the invitation from the recruiter and enters the invitation code into the computer network.

Step S112 of the method of the preferred embodiment recites allowing the recruiter to access the contact information of the company. Preferably, the step of allowing the recruiter to access the contact information of the company occurs only if the if the company accepts the invitation from the recruiter and enters the invitation code into the computer network. Further, Step S112 also includes preventing other recruiters from accessing the contact information of the company. This step functions as another type of clearinghouse for the company to the extent that, at the company's discretion, it may automatically authorize only a designated preferred recruiter to access its contact information. Those recruiters that are not designated as preferred recruiters will not have access to the company's contact information, and therefore will be less likely to submit candidate information to the company. Accordingly, this step aids in the streamlining and efficiency of the selection process by protecting the company from receiving unsolicited, non-preferred or otherwise undesirable submissions from a non-designated recruiter.

In a fifth variation of the method of the preferred embodiment, Step S106 also includes—upon the selection by the company of a candidate for the available position—receiving payment from the company and transmitting a portion of the payment to the recruiter and a portion of the payment to the inviter of the company. The total amount transferred to the inviter of the company may be limited on a company basis, on a recruiter basis, or on any other suitable basis. The amount transferred may be dependent on the time elapsed between the invitation of the company and the selection of a candidate.

In a fifth variation of the method of the preferred embodiment, Step S106 may further include posting information about the invitation history for the recruiter and the payments to the recruiter either on a periodic basis or a real-time basis. This step functions to distinguish one or more recruiters from each other, thereby allowing the company to more competitively select a proper recruiter and/or block any undesirable recruiters. Moreover, posting of the invitation history functions to inform other recruiters about the success rate of their respective competition, thereby increasing each party's incentive to perform well in the submission step. In one version, the invitation history includes one of the following measurements: number of invitations, number of acceptances of the invitations, ratio of the number of acceptances to the number of invitations, an amount paid to the inviter or any combination thereof.

In a sixth variation of the method of the preferred embodiment, Step S108 also includes limiting the number of companies that the recruiter may invite to the computer network. This limitation functions to provide an incentive the recruiters to invite only companies that would benefit from the computer network. The limitation may be based on a predetermined number, such as ten invitations. The number may be increased if the invited company accepts the invitation. For example, if the recruiter has ten invitations, gives one invitation to a company, and the company accepts, then the recruiter would again have ten invitations. In different versions, the number may only be increased if the invited company is not already within the computer network, if the company actually posts information about an available position for the company, if the company actually selects a candidate for an available position, or if the company actually transmits payment for the bounty for the filling of the available position. This step functions to increase the efficiency of the invitation process by preventing recruiters from inviting an unsuitable number of companies with available positions. To the extent that each recruiter is so limited, then each recruiter will have additional incentive, time and energy to most effectively submit information for more worthy candidates for the limited number of available positions. The limited number may be universally applied to every recruiter, or it may be individualized for each recruiter, or it may be determined according to a formula or combination of factors. For example, the limited number may be based on one of the following measurements: number of submissions, number of selections of the candidates submitted to the recruiter, ratio of number of submissions to number of selections of the candidates submitted by the recruiter, an amount paid to the recruiter or any combination thereof. Alternatively, the limited number may be based on, for each recruiter, the number of designations as a blocked recruiter or a number of designations as a preferred recruiter, or any ratio or combination there of. Alternatively, the limited number may be based on various qualitative judgments or rankings from companies for which the recruiter has performed in the past, or any combination of quantitative and qualitative factors or judgments indicative of the limited number of active listings to which the recruiter should be entitled.

In a seventh variation of the method of the preferred embodiment, Step S108 also includes limiting the number of companies that the recruiter may invite to the computer network based on the ratio of available positions and potential candidates. This limitation, unlike the above limitation, primarily functions to balance the marketplace of available positions and potential candidates. The limitation may, however, also function to provide an incentive the recruiters to invite only companies that would benefit from the computer network. For example, if the ratio of available position to potential candidates decreases below an optimal level, then each recruiter (or a sample, such as the top performing, of the recruiters) may receive an extra number of invitations, such as one or two. Because the bounties paid by invited companies may be shared with the inviter of the company, the invitations may be used as incentives to increase the number of companies in the computer network. The increased number of companies hopefully increases the number of available positions in the computer network and adjusts the ratio of available positions to potential candidates towards the optimal level.

All of the foregoing steps, variations and alternatives thereof may be performed by one or more parties through a computer network of the type described above. The computer network may include for example a website including software adapted to perform each step, variation and alternative thereof noted herein. Such a website may be operated by an intermediary.

Although omitted for conciseness, the preferred embodiments include every logical combination and permutation of the above variations, alternatives, and versions of the preferred embodiment.

As a person skilled in the art will recognize from the previous detailed description and from the figures and claims, modifications and changes may be made to the preferred embodiments of the invention without departing from the scope of this invention defined in the following claims.

I claim:

1. A method to encourage a recruiter to engage a company with an available position, the method comprising the steps of:
a) allowing the recruiter to invite a company to a computer network that:
accepts information about the available position from the company;
accepts information about a candidate for the available position from a recruiter and submits the information about the candidate for the available position to the company; and
upon the selection by the company of a candidate for the available position, accepts payment from the company and transmits a portion of the payment to the recruiter; and
b) accepting contact information for the company; and
c) allowing the recruiter to access the contact information of the company.

2. The method of claim 1, wherein step (a) includes creating and transmitting an invitation code to the company.

3. The method of claim 2, wherein step (b) includes accepting the invitation code from the company, and then accepting contact information for the company.

4. The method of claim 3, wherein step (c) is performed only upon the acceptance of the invitation code from the company.

5. The method of claim 3, where step (a) includes checking a database of companies within the computer network and if the invited company is not within the computer network, then performing step (b) and step (c), otherwise informing the recruiter that the company is already within the computer network.

6. The method of claim 1, wherein upon the selection by the company of a candidate for the available position, the computer network accepts payment from the company and transmits a portion of the payment to the recruiter and a portion of the payment to the inviter of the company.

7. The method of claim 6, further comprising posting information about the invitation history for the recruiter.

8. The method of claim 1, wherein step (a) includes allowing the recruiter to invite a limited number of companies to a computer network.

9. The method of claim 1, wherein step (a) includes allowing the recruiter to invite a predetermined number of companies to a computer network.

10. The method of claim 9, wherein the predetermined number is increased if the invited company accepts the invitation.

11. The method of claim 9, wherein the predetermined number is increased if the invited company is not already within the computer network.

12. The method of claim 9, wherein the predetermined number is increased if the company posts information about an available position for the company.

13. The method of claim 12, wherein the predetermined number is increased if the company selects a candidate for the available position.

14. The method of claim 13, wherein the predetermined number is increased if the company transmits payment.

15. The method of claim 9, wherein the predetermined number is based on the number of available positions within the computer network.

16. The method of claim 15, wherein the predetermined number is based on a ratio of the number of available positions within the computer network to the number of potential candidates within the computer network.
